(19) United States
(12) Patent Application Publication
(10) Pub. No.: US 2024/0242084 A1
(43) Pub. Date: Jul. 18, 2024

(54) ESTIMATION DEVICE, ESTIMATION METHOD, AND RECORDING MEDIUM

(71) Applicant: NEC Corporation, Minato-ku, Tokyo (JP)

(72) Inventors: Shumpei Kubosawa, Tokyo (JP); Takashi Onishi, Tokyo (JP)

(73) Assignee: NEC Corporation, Minato-ku, Tokyo (JP)

(21) Appl. No.: 18/288,217

(22) PCT Filed: May 6, 2021
(86) PCT No.: PCT/JP2021/017409

§ 371 Date: Oct. 25, 2023

(51) Int. Cl. G06N 3/092

(52) U.S. Cl. CPC G06N 3/092

(57) ABSTRACT

An estimation device estimates the relationships among a plurality of items, on the basis of at least one of: the state of a prediction model that receives input of past values of the items or past values of some of the items and then outputs a prediction value for at least one of the items; and differences in the prediction accuracy of the prediction model with respect to different inputs.

### TECHNICAL FIELD

The present invention relates to an estimation device, an estimation method, and a recording medium.

### BACKGROUND ART

When Artificial Intelligence (AI), for example, is used to control each device, robot, or other control target in a plant, it is necessary to check the validity of the AI analysis results and, if valid, to control the control target according to the output of the AI or the like. As one such example, a method has been proposed that constructs an equation that represents the relationship among multiple observation points in systems like plants, and analyzes the correlation between these observation points.

For example, Patent Document 1 describes a method for estimating the pipelines used for flow in and out at a water storage facility based on the amount of water stored in the storage facility and the inflow and outflow quantities of each of a plurality of pipelines connected to the storage facility.

In the method described in Patent Document 1, an equation is constructed for each of several times to show that the sum of the inflow and outflow quantities of the pipelines is equal to the change in the amount of water stored in the water storage facility. The pipeline inflow and outflow quantities are multiplied by a coefficient whose value is unknown. The method described in Patent Document 1 then determines the coefficient value of the pipeline inflow and outflow quantities so that the total sum of squared errors between the sum of the inflow and outflow quantities of the pipelines and the changes in the storage volume of the water storage facility becomes minimized for all time points. The method described in Patent Document 1 estimates that the pipelines with determined coefficient values close to −1 or 1 are the pipelines used for inflow and outflow at the water storage facility.

### PRIOR ART DOCUMENTS

### Patent Documents

Patent Document 1: PCT International Publication No. WO 2016/027528

### SUMMARY OF THE INVENTION

### Problems to be Solved by the Invention

If the relationships among these items can be estimated without the need to construct a mathematical model showing the relationships among multiple items, the burden on the person in charge to construct a mathematical model can be reduced, and the relationships can be estimated even when a mathematical model cannot be constructed.

An example of an object of the present invention is to provide an estimation device, an estimation method, and a recording medium that can solve the above-mentioned problem.

### Means for Solving the Problem

According to the first example aspect of the invention, an estimation device is provided with an estimation means that estimates the relationships among a plurality of items, on the basis of: the state of a prediction model that receives input of past values of the items or past values of some of the items and then outputs a prediction value for at least one of the items; and/or differences in the prediction accuracy of the prediction model with respect to different inputs.

According to the second example aspect of the invention, an estimation method includes estimating the relationships among a plurality of items, on the basis of: the state of a prediction model that receives input of past values of the items or past values of some of the items and then outputs a prediction value for at least one of the items; and/or differences in the prediction accuracy of the prediction model with respect to different inputs.

According to the third example aspect of the invention, a recording medium is a recording medium that records a program for causing a computer to perform a program that estimates the relationships among a plurality of items, on the basis of: the state of a prediction model that receives input of past values of the items or past values of some of the items and then outputs a prediction value for at least one of the items; and/or differences in the prediction accuracy of the prediction model with respect to different inputs.

### Effects of Invention

According to the present invention, the relationships among a plurality of items can be estimated without the need to construct a mathematical model showing the relationships among a plurality of items.

### BRIEF DESCRIPTION OF THE DRAWINGS

FIG. 1 is a schematic block diagram showing an example of the system configuration according to the first example embodiment.

FIG. 2 is a diagram showing an example of the configuration of the estimation device according to the first example embodiment.

FIG. 3 is a diagram showing a first example of the prediction model according to the first example embodiment.

FIG. 4 is a diagram showing an example of the processing procedure in which the estimation device according to the first example embodiment estimates the correlation between items based on the prediction accuracy by the prediction model.

FIG. 5 is a diagram showing the second example of the prediction model according to the first example embodiment.

FIG. 6 is a diagram showing an example of a procedure in which the estimation device according to the first example embodiment estimates correlation between items using a prediction model that includes weighted nodes for the input items.

FIG. 7 is a diagram showing an example of a configuration in which the model processing portion according to the first example embodiment performs weighting of input items to the prediction model.

FIG. 8 is a diagram showing an example of the processing procedure in which the estimation device estimates the correlation between items when the model processing portion according to the first example embodiment performs weighting for the input items to the prediction model.

FIG. 9 is a diagram showing an example of the configuration of the estimation device according to the second example embodiment.

FIG. 10 is a diagram showing an example of the configuration of the estimation device according to the third example embodiment.

FIG. 11 is a diagram showing an example of the configuration of the estimation device according to the fourth example embodiment.

FIG. 12 is a diagram showing an example of the processing procedure in the estimation method according to the fifth example embodiment.

FIG. 13 is a schematic block diagram of a computer according to at least one example embodiment.

### EXAMPLE EMBODIMENT

The following is a description of example embodiments of the invention, however, these example embodiments are not intended to limit the scope of the invention as claimed. Not all of the combinations of features described in the example embodiments are essential to the solution of the invention.

### First Example Embodiment

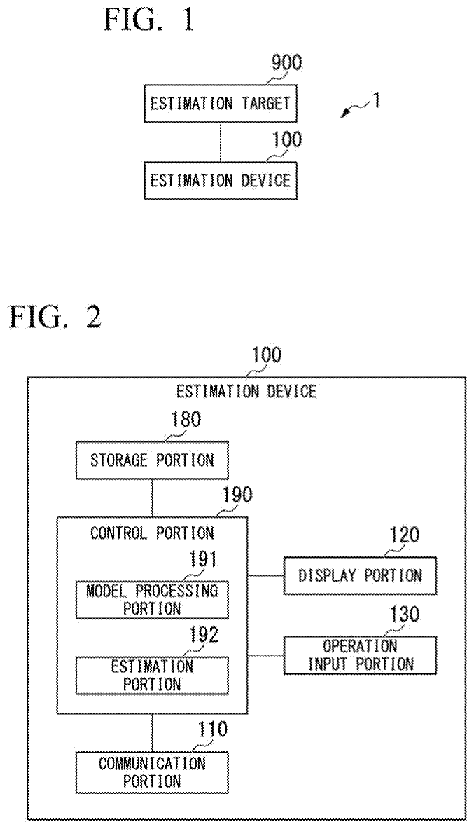

FIG. 1 is a schematic block diagram showing an example of the system configuration according to the first example embodiment. In the configuration shown in FIG. 1, a system 1 is provided with an estimation device 100 and an estimation target 900.

The estimation target 900 is the target of estimation by the estimation device 100. The estimation target 900 has a plurality of items for which the estimation device 100 can obtain values, and the estimation device 100 estimates the relationship between the plurality of items in the estimation target 900.

The following is an example of a case in which the estimation device 100 estimates the correlation between multiple items in the estimation target 900. However, the relationships that the estimation device 100 estimates are not limited to any particular one. For example, the estimation device 100 may estimate causality. The same is true for an estimation device 200 and an estimation device 300.

The items in the estimation target 900 are not limited to any particular type, as long as the estimation device 100 is capable of acquiring values for the items.

For example, the items in the estimation target 900 may include an item to be measured by a sensor.

If the item in the estimation target 900 is an item to be measured by a sensor, the item may be an item in the estimation target 900 itself, such as a current at a given location in the estimation target 900. Alternatively, the item may be an item related to the ambient environment of the estimation target 900, such as the room temperature of the room in which the estimation target 900 is installed.

The items in the estimation target 900 may include operations on the estimation target 900, or control commands to the estimation target 900, or both. If the item in the estimation target 900 is an operation on the estimation target 900, the operation amount can be used as the item value. If the item in the estimation target 900 is a control command for the estimation target 900, the control command value can be used as the item value.

An item in the estimation target 900 is also referred to simply as an item.

The estimation device 100 acquires the past values of the items in the estimation target 900 and predicts the item values in the future from the time when the past values were observed. The term past value here refers to a value at a point in time preceding the prediction target time. An item value obtained by prediction is also referred to as a predicted value.

In the following, time is denoted by sequential numbers for each time step, such as 1, . . . , t−1, t, t+1, and so on. The estimation device 100 shall obtain past values at each time in the time step and predict the item value at a time in the future compared to the time when the past values were observed. For example, the estimation device 100 acquires time series data of item values up to time 1, . . . , t−1, and t, and predicts the item value at time t+1.

The time does not necessarily have to be per step, but may be represented by time steps in which mutually different step intervals are included, such as a mixture of two steps and one step. Alternatively, the time may be represented by a continuous value. The way time is represented is not limited to the examples described above. For the sake of explanation, it shall be assumed that time series data of item values are acquired for each time up to time 1, . . . , t−1, and t.

The estimation target 900 can be a variety of items from which the estimation device 100 can obtain past values, and is not limited to any particular item. For example, the estimation target 900 may be, but is not limited to, any of the following: a chemical plant, a distillation column, an air traffic control system, or a rail system.

The estimation target 900 may be a system that includes multiple devices, a single device, or a portion of a device.

The estimation device 100 calculates prediction values using a prediction model that receives an input of a past value and outputs a prediction value. The estimation device 100 also uses this prediction model to estimate correlations between items. Items that serve as inputs to the prediction model are also referred to as input items. Items that are output from the prediction model are also referred to as output items.

A prediction model can be any trainable model and is not limited to a specific type of model. For example, the prediction model may consist of, but is not limited to, a neural network or machine learning algorithm such as a support vector machine.

The estimation device 100 is composed of, for example, a computer.

FIG. 2 shows an example of the configuration of the estimation device 100. In the configuration shown in FIG. 2, the estimation device 100 is provided with a communication portion 110, a display portion 120, an operation input portion 130, a storage portion 180, and a control portion 190. The control portion 190 is provided with a model processing portion 191 and an estimation portion 192.

The communication portion 110 communicates with other devices. For example, the communication portion 110 may communicate with the estimation target 900 to receive past values from the estimation target 900 at each time in the time step. Alternatively, the communication portion 110 may receive training data by past values of items in the estimation target 900 from a server device that provides training data. This training data may be used to train prediction models.

The display portion 120 is provided with a display screen, such as a liquid crystal panel or LED (Light Emitting Diode) panel, for example, and displays various images. For example, the display portion 120 may display the result of the correlation estimation by the estimation device 100.

The operation input portion 130 is provided with input devices such as a keyboard and mouse, for example, and receives user operations. For example, the operation input portion 130 may receive a user operation that instructs the estimation of correlations between items.

The storage portion 180, which stores various data, is configured using a storage device provided by the estimation device 100.

The control portion 190 controls various parts of the estimation device 100 and performs various processes. The functions of the control portion 190 may be performed by a central processing unit (CPU) provided by the estimation device 100 reading a program from the storage portion 180 and executing the program.

The model processing portion 191 performs various processes related to the prediction model. The prediction model here is a model that receives inputs of past values of multiple items or past values of some of those items and outputs a prediction values of one or more items. The output item may be the same as or different from the input item.

The model processing portion 191, for example, calculates prediction values by inputting past values into the prediction model. The model processing portion 191 also controls the training of a prediction model.

The model processing portion 191 corresponds to an example of a model processing means.

The estimation portion 192 estimates correlations between items using the prediction model.

The estimation portion 192 corresponds to an example of an estimation means.

The estimation portion 192 may estimate a correlation between items based on the accuracy of the prediction made by the prediction model.

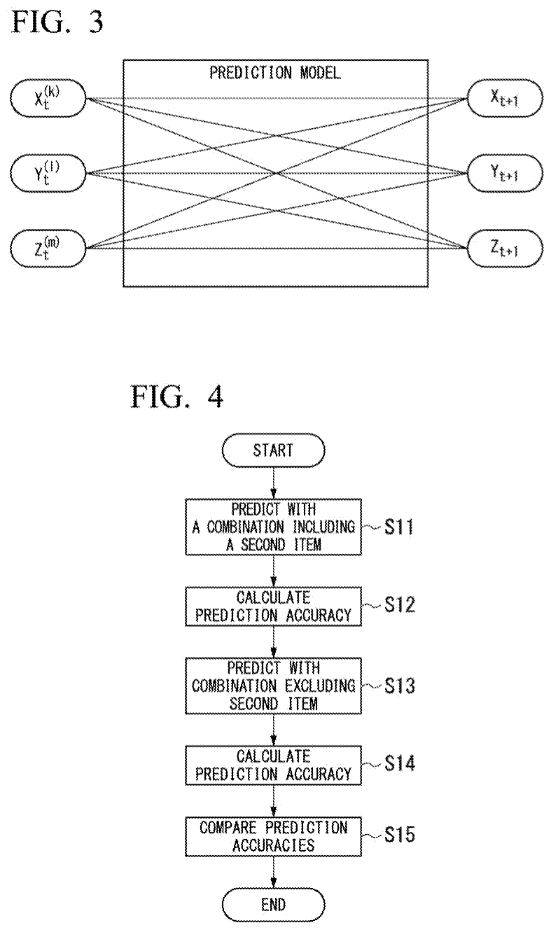

FIG. 3 is a diagram showing a first example of a prediction model. FIG. 3 shows an example where a prediction model receives inputs of past values for items X, Y, and Z and outputs prediction values for items X, Y, and Z, respectively. The values of items X, Y, and Z may be sensor measurement values by sensors X, Y, and Z provided in the estimation target 900.

However, the number of input items to the prediction model can be two or more, and is not limited to a specific number. The prediction model may output prediction values for only some of the input items. Input items to the prediction model are not limited to sensor-based items.

In the example in FIG. 3, the prediction model receives inputs of time series data Xₜ^{(k)} of past values of item X, time series data Yₜ^{(l)} of past values of item Y, and time series data Zₜ^{(m)} of past values of item Z.

Xₜ^{(k)} represents the time series data of past values of item X at times from time t to k steps (k is a natural number) prior to time t. It is expressed as Xₜ^{(k)}=Xₜ₋ₖ, . . . Xₜ. Similarly, Yₜ^{(l)}=Yₜ₋₁, . . . Yₜ (l is a natural number). Zₜ^{(m)}=Zₜ₋ₘ, . . . Zₜ (m is a natural number). k, l and m may be the same or different values.

In response to the input of Xₜ^{(k)}, Yₜ^{(l)} and Zₜ^{(m)}, the prediction model outputs the prediction value Xₜ₊₁ of item X at time t+1, the prediction value Yₜ₊₁ of item Y at time t+1, and the prediction value Zₜ₊₁ of item Z at time t+1.

The estimation portion 192 estimates correlations between items based on differences in prediction accuracy due to differences in the input items to the prediction model.

For example, the model processing portion 191 calculates the prediction value Xₜ₊₁ when both time-series data Xₜ^{(k)} and Yₜ^{(l)} are input to the prediction model, and the prediction value Xₜ₊₁ when only Xₜ^{(k)} out of Xₜ^{(k)} and Yₜ^{(l)} are input to the prediction model. The estimation portion 192 estimates whether or not items X and Y are correlated based on the difference in prediction accuracy when both time-series data Xₜ^{(k)} and Yₜ^{(l)} are input to the prediction model and when only Xₜ^{(k)} out of Xₜ^{(k)} and Yₜ^{(l)} is input to the prediction model.

When both time-series data Xₜ^{(k)} and Yₜ^{(l)} are input to the prediction model, the prediction value Xₜ₊₁ is expressed as in Equation (1).

$$\begin{matrix}[ Equation 1 ] & \\ {X}_{t + 1} = f ( {X}_{t}^{( k )} , {Y}_{t}^{( l )} ) & ( 1 )\end{matrix}$$

When only Xₜ^{(k)} of the time-series data Xₜ^{(k)} and Yₜ^{(l)} is input to the prediction model, the prediction value Xₜ₊₁ is expressed as in Equation (2).

$$\begin{matrix}[ Equation 2 ] & \\ {X}_{t + 1} = f ( {X}_{t}^{( k )} ) & ( 2 )\end{matrix}$$

Since the same prediction model is used when both time-series data Xₜ^{(k)} and Yₜ^{(l)} are input to the prediction model and when only Xₜ^{(k)} of the time-series data Xₜ^{(k)} and Yₜ^{(l)} are input to the prediction model, the prediction model is represented by a function f in both equations (1) and (2).

If the prediction accuracy of the prediction value Xₜ₊₁ is higher in the case of Equation (1) than in the case of Equation (2), it can be inferred that there is a correlation between items X and Y. On the other hand, if the prediction accuracy of the prediction value Xₜ₊₁ is the same in the case of Equation (1) as in the case of Equation (2), then items X and Y can be estimated to be uncorrelated. Non-correlation here is the absence of correlation.

For example, the estimation portion 192 calculates the difference between the prediction accuracy of the prediction value Xₜ₊₁ when both time-series data Xₜ^{(k)} and Yₜ^{(l)} are input to the prediction model and the prediction accuracy of the prediction value Xₜ₊₁ when only Xₜ^{(k)} of the Xₜ^{(k)} and Yₜ^{(l)} are input to the prediction model. The estimation portion 192 compares the calculated difference with a predetermined threshold value, and if the difference is determined to be greater than or equal to the threshold value, it estimates that there is a correlation between items X and Y. On the other hand, if the difference is determined to be smaller than the threshold, the estimation portion 192 estimates that items X and Y are uncorrelated. In this case, the predetermined threshold value represents the criterion for determining whether or not items are correlated.

Prediction accuracy here can be any comparable measure and is not limited to a specific type of prediction accuracy.

For example, the estimation portion 192 may calculate the magnitude of the error between the prediction value calculated by the model processing portion 191 and the prediction value presented as correct in the training data as the prediction accuracy. In this case, the estimation portion 192 evaluates higher prediction accuracy when the magnitude of the error is smaller.

Alternatively, the model processing portion 191 may calculate multiple time prediction values for each of the multiple combinations of input items to the prediction model. The estimation portion 192 may then compare the magnitude of the error between the prediction value and the correct answer to a predetermined threshold value for each combination of input items and at each time to determine whether the prediction is correct or erroneous. The estimation portion 192 may then calculate the percentage of correct answers for each combination of input items and use it as the prediction accuracy.

FIG. 4 shows an example of the processing procedure in which the estimation device 100 estimates correlations between items based on the prediction accuracy by the prediction model. FIG. 4 shows an example where the model processing portion 191 calculates a prediction value for the first item, and the estimation portion 192 estimates the correlation between the first item and the second item.

In the process shown in FIG. 4, the model processing portion 191 inputs past values in a combination of items including the first item and the second item into a prediction model to calculate the prediction value of the first item (Step S11).

The estimation portion 192 compares the prediction value of the first item calculated by the model processing portion 191 in Step S11 with the correct data to calculate the prediction accuracy of the first item (Step S12).

The model processing portion 191 inputs the past values of items excluding the second item from the combination of items in Step S11 into the prediction model to calculate the prediction value of the first item (Step S13).

The estimation portion 192 calculates the prediction accuracy of the first item calculated by the model processing portion 191 in Step S13 (Step S14).

The estimation portion 192 then compares the prediction accuracy calculated in Step S12 with the prediction accuracy calculated in Step S14 to estimate the correlation between the first item and the second item (Step S15).

For example, the estimation portion 192 calculates the difference by subtracting the prediction accuracy calculated in Step S14 from the prediction accuracy calculated in Step S12. The estimation portion 192 compares the calculated difference with the predetermined threshold value to determine whether the prediction accuracy calculated in Step S12 is equal to or greater than the threshold value. If the accuracy is determined to be equal to or greater than the threshold, the estimation portion 192 estimates that there is a correlation between the first item and the second item. On the other hand, if it is determined that the accuracy is not equal to or greater than the threshold value, the estimation portion 192 estimates that the first item and the second item are not correlated.

After Step S15, the estimation device 100 ends the process in FIG. 4.

The estimation portion 192 may estimate the strength of the correlation in addition to or instead of the presence or absence of correlation between items.

For example, in Step S15, the estimation portion 192 may output the difference between the prediction accuracy calculated in Step S12 and the prediction accuracy calculated in Step S14 as an index value indicating the strength of the correlation.

If the prediction accuracy of the value of the first item is higher when the second item is added to the input items than when it is not added, the estimation portion 192 may estimate that there is a causal relationship where the second item is a factor and the first item is a result.

For example, if, in Step S15, the estimation portion 192 determines that the prediction accuracy calculated in Step S12 is more accurate than the prediction accuracy calculated in Step S14 by an amount equal to or greater than the threshold value, it may estimate that there is a causal relationship where the second item is a factor and the first item is a result.

The estimation portion 192 may estimate correlations between items based on the weightings for the input items in the prediction model.

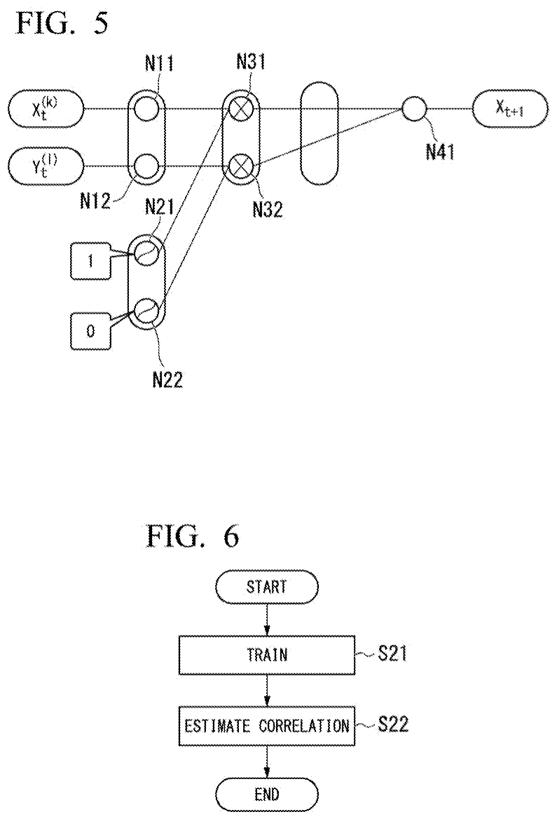

FIG. 5 shows a second example of a prediction model. FIG. 5 shows an example of a prediction model that includes weighted nodes for input items. FIG. 5 also shows an example in which the prediction model receives inputs of past values for two items, X and Y, and outputs a prediction value for item X.

However, as explained with reference to FIG. 3, the number of input items to the prediction model can be two or more, and is not limited to a specific number. The prediction model may output predictions for only some of the input items, or it may output predictions for all of the input items. Input items to the prediction model are not limited to specific types of items, such as items from sensors.

In the example in FIG. 5, nodes N11 and N12 are input nodes. Nodes N21 and N22 are weight nodes. Nodes N31 and N32 are weighted nodes. Node N41 is the output node. Processing may take place in the layer between nodes N31 and N32 and node N41 for the output of node N31 and the output of N32.

Node N11 receives input of time series data Xₜ^{(k)} of past values of item X. Node N11 may output the past values of item X as is, or processing on the past values of item X may be performed in node N11.

Node N12 receives input of time series data Yₜ^{(l)} of past values of item Y. Node N12 may output the past values of item Y as is, or processing on the past values of item Y may be performed in node N12.

Node N21 stores the weights for the past values of item X. In the example in FIG. 5, the weight for the past value of item X is 1.

Node N22 stores the weights for the past values of item Y. In the example in FIG. 5, the weight for the past value of item Y is 0.

Node N31 performs weighting on the past values of item X by multiplying the value of node N11 by the value of node N21. Node N32 performs weighting on the past values of item X by multiplying the value of node N12 by the value of node N22.

If the weight stored by the weight node is either 1 or 0, as in the example in FIG. 5, the weighting by the weighting node serves as a mask for the input data. In the example in FIG. 5, node N21 has a value of 1, so the time-series data Xₜ^{(k)} of the past values of item X is used to calculate the prediction value Xₜ₊₁ of item X. In contrast, since the value of node N22 is 0, the time-series data Yₜ^{(l)} of the past values of item Y is not used to calculate the prediction value Xₜ₊₁ of item X.

However, the weights stored by weight nodes are not limited to 1 or 0. For example, a weight node may store a real number between 0 and 1 as a weight.

Some constraint condition may be placed on the weights stored by the weight nodes, such as the sum of all weights stored by the weight nodes being 1.

When the model processing portion 191 trains the prediction model, the weights stored by the weight nodes are also included in the training target.

Training the prediction model here means adjusting the parameter values of the prediction model based on the training data. For example, the model processing portion 191 acquires training data that includes time series data Xₜ^{(k)} of past values of item X, time series data Yₜ^{(l)} of past values of item Y, and the correct value of the prediction value Xₜ₊₁ of item X. The model processing portion 191 then adjusts the parameter values of the prediction model, such as the weights stored by the weight nodes, so that the value of node N41 approaches the correct value.

The weights in the trained prediction model can be thought of as representing the contribution of the item being weighted to the calculation of the prediction value. The larger the contribution of an item, the stronger the correlation with the output item for which the prediction value is calculated can be considered.

Therefore, the estimation portion 192 estimates the correlations between items based on the weights in the trained prediction model.

As in the example in FIG. 5, when the weight takes a value of 1 or 0, the estimation portion 192 may estimate that an input item weighted with weight 1 is correlated with the output item and an input item weighted with weight 0 is uncorrelated with the output item.

Alternatively, if the weight is a real value greater than 0 and less than 1, the estimation portion 192 may compare the weight to a predetermined threshold value. The estimation portion 192 may then estimate that the input item weighted with a weight greater than the threshold is correlated with the output item and the input item weighted with a weight less than the threshold is uncorrelated with the output item.

The estimation portion 192 may estimate the strength of the correlation in addition to or instead of the presence or absence of correlation between items.

For example, the estimation portion 192 may output the weight of each input item as an index value indicating the strength of the correlation between that input item and the output item.

FIG. 6 is a diagram showing an example of the processing procedure in which the estimation device 100 estimates correlations between items using a prediction model that includes weighted nodes for the input items.

In the process shown in FIG. 6, the model processing portion 191 trains the prediction model using the training data (Step S21). The model processing portion 191 includes weights that are weighted to input items in the training target to train the prediction model.

Next, the estimation portion 192 estimates the correlation between items based on the weights in the trained prediction model (Step S22). For example, when the weight takes a value of 1 or 0, the estimation portion 192 estimates that an input item weighted with weight 1 is correlated with output item and the input items weighted with weight 0 is uncorrelated with output item.

After Step S22, the estimation device 100 ends the process in FIG. 6.

Instead of weighting input items in the prediction model, the model processing portion 191 may weight input items to the prediction model.

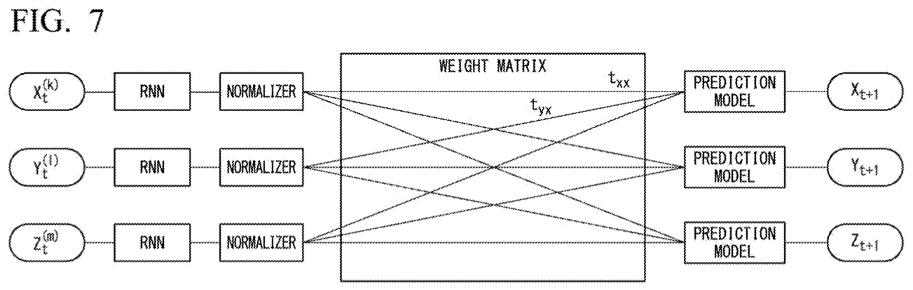

FIG. 7 shows an example of a configuration in which the model processing portion 191 assigns weights to input items to the prediction model. The configuration illustrated in FIG. 7 may be part of the model processing portion 191.

FIG. 7 shows an example of when the model processing portion 191 inputs weighting to the prediction model for the time series data Xₜ^{(k)}, Yₜ^{(l)}, and Zₜ^{(m)} of past values for items X, Y, and Z. In the example in FIG. 7, the prediction model outputs predictions Xₜ₊₁, Yₜ₊₁ and Z_{t+1.}

However, as explained in FIGS. 3 and 5, the number of inputs to the prediction model can be two or more, and is not limited to a specific number. The prediction model may output a prediction value for only some of the input items, or it may output a prediction value for all of the input items. Input items to the prediction model are not limited to specific types of items, such as items from sensors.

In the example in FIG. 7, the time series data Xₜ^{(k)}, Yₜ^{(l)}, and Zₜ^{(m)} are each input to the weight matrix via a recurrent neural network (RNN) and a normalizer.

The recurrent neural network is provided in order to reflect the multiple time data included in the time series data in the input values to the prediction model.

The normalizer performs normalization to align the range of possible input values to the weight matrix among input items. The normalizer may use, but is not limited to, the batch normalization method in Convolutional Neural Networks (CNNs) as a method of normalization.

The weight matrix performs weighting of the input data to the prediction model for each input item and for each prediction model. The weight matrix t in the example in FIG. 7 is shown in Equation (3).

$$\begin{matrix}[ Equation 3 ] & \\ τ = [ \begin{matrix}{t}_{xx} & {t}_{xy} & {t}_{xz} \\ {t}_{yx} & {t}_{yy} & {t}_{yz} \\ {t}_{zx} & {t}_{zy} & {t}_{zz}\end{matrix} ] & ( 3 )\end{matrix}$$

Each element of the matrix is used as a weight for the prediction model. Subscripts under the element name indicate the input item name and output item name in lower case.

For example, the time-series data Xₜ(k) of past values of item X are multiplied by the weight the weight tₓₓ as the weight for the data that passed through the RNN and normalizer. The data weighted by the weight tₓₓ is input into the prediction model, which outputs the prediction value Xₜ₊₁ for item X.

The time-series data Yₜ^{(l)} of past values of item Y are multiplied by the weight the weight t_{yz} as the weight for the data that passed through the RNN and normalizer. The data weighted by the weight t_{yz} is input into the prediction model, which outputs the prediction value Zₜ₊₁ for item Z.

The weights, which are the element of the weight matrix, are set by the model processing portion 191. The model processing portion 191 may randomly set the value of each element of the weight matrix in the range of real numbers greater than or equal to 0 and less than or equal to 1. The range of elements in this case is shown in Equation (4).

$$\begin{matrix}[ Equation 4 ] & \\ {t}_{**} ∈ [ 0 , 1 ] & ( 4 )\end{matrix}$$

In Equation (4), “*” indicates a wildcard that takes any of the values “x”, “y”, or “z”.

The model processing portion 191 repeats the training of the prediction model using the same training data for each weight matrix setting. Input items for which the values of the weight is set high in training with high prediction accuracy are considered to be highly correlated with the output items.

Therefore, the estimation portion 192 may rank the training result for each output item in descending order of predictive accuracy of the prediction value. The estimation portion 192 may then estimate that the input items whose weights are set high in the training results with high prediction accuracy have a strong correlation with the output items.

For example, the estimation portion 192 may select, for each output item, a learning result for which the prediction accuracy is equal to or greater than a predetermined threshold, and calculate the average value in all training results for each of the weights for the input data to the prediction model that outputs the prediction value for that output item. The estimation portion 192 may then use the calculated average value as an index value indicating the strength of the correlation between output items and input items.

Further, for example, the estimation portion 192 selects the training results in which the estimation accuracy of the prediction value Xₜ₊₁ of item X is equal to or greater than a predetermined threshold. The estimation portion 192 then calculates the average value in the selected training results for each of the weights tₓₓ, t_{yx}, and t_{zx} for the input data to the prediction model that outputs the prediction Xₜ₊₁. The estimation portion 192 calculates the calculated average value as an index value indicating the strength of the correlation between the input item and output item.

Alternatively, the estimation portion 192 may compare the calculated average value to a predetermined threshold value, and if the average value is equal to or greater than the threshold value, estimate that the input item is correlated with the output item, and if the average value is below the threshold value, estimate that the input item is uncorrelated with the output item.

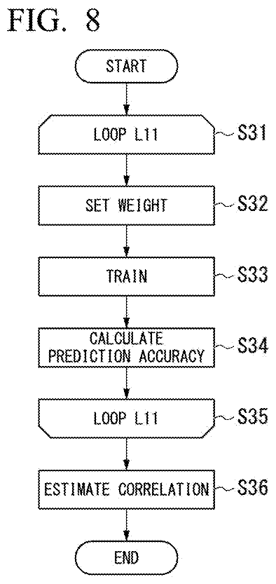

FIG. 8 shows an example of the procedure in which the estimation device 100 estimates the correlation between items when the model processing portion 191 performs weighting for the input items to the prediction model.

In the process of FIG. 8, the estimation device 100 starts a loop L11 to repeat the training of the prediction model (Step S31).

Next, the model processing portion 191 sets the value of each element of the weight matrix (Step S32). The elements of the weight matrix are used as weights for the input data to the prediction model. The model processing portion 191 may randomly set the value of each element of the weight matrix to a real-valued range between 0 and 1.

Next, the model processing portion 191 trains the prediction model (Step S33). The model processing portion 191 may initialize the parameter values of the prediction model each time Step S33 is performed, and then train the prediction model using the same training data.

The recurrent neural network and normalizer can be used in common for each training once the setup is complete. Therefore, there is no need to train the recurrent neural network and normalizer for each Step S33 process.

Next, the estimation portion 192 calculates the prediction accuracy of the prediction value for each output item based on the training results in Step S33 (Step S34).

The estimation device 100 then performs the termination of the loop L11 (Step S35). The estimation device 100 repeats the loop L11 a predetermined number of times.

After the estimation device 100 completes the process of loop L11, the estimation portion 192 estimates the correlation between items (Step S36). For example, the estimation portion 192 ranks the training results for each output item in descending order of predictive accuracy of the predictions as described above, and estimates the correlation between items based on the weights in the training results with the highest predictive accuracy.

After Step S36, the estimation device 100 terminates the process in FIG. 8.

As described above, the estimation portion 192 estimates the relationships among items using a prediction model that receives inputs of past values of multiple items or past values of some of those items and outputs predictions for one or more items.

The estimation device 100 can train this prediction model. According to the estimation device 100, in this respect, the relationship between these items can be estimated without the need to build a mathematical model showing the relationship between multiple items.

The estimation portion 192 estimates the relationship between a first item and a second item based on the prediction accuracy of the prediction value of the first item output by the prediction model for the input of past values in a combination of items including the first item and the second item, and the prediction accuracy of the prediction value of the first item output by the prediction model for the input of past values of items excluding the second item from that item combination.

The estimation device 100 can train this prediction model. According to the estimation device 100, in this respect, the relationship between these items can be estimated without the need to build a mathematical model showing the relationship between multiple items.

According to the estimation device 100, the relationship between items can be estimated using a trained prediction model, and the relationship can be estimated in a relatively short time, in that it is not necessary to perform training each time to estimate the correlation.

According to the estimation device 100, the estimation of relationships can be repeated with the input of fluid data, and in this respect, dynamically changing relationships can be estimated.

The prediction model includes a weighting node that performs weighting for past values with a weight of each item. Training of the prediction model includes training of the weight of each item. The estimation portion 192 estimates the relationship between items based on the weights in the trained prediction model.

According to the estimation device 100, the relationship between items can be estimated by training a prediction model, and in this respect, the relationship between these items can be estimated without the need to build a mathematical model showing the relationship between multiple items.

The model processing portion 191 performs multiple weightings for multiple items and performs training to predict the value of the same item using the prediction model at each weighting. The estimation portion 192 estimates the relationship between items based on the prediction accuracy of the value of the same item by the trained prediction model with each weighting.

According to the estimation device 100, the relationship between items can be estimated by training a prediction model, and in this respect, the relationship between these items can be estimated without the need to build a mathematical model showing the relationship between multiple items.

### Second Example Embodiment

The second example embodiment describes an example of the method of using the estimation device 100 according to the first example embodiment.

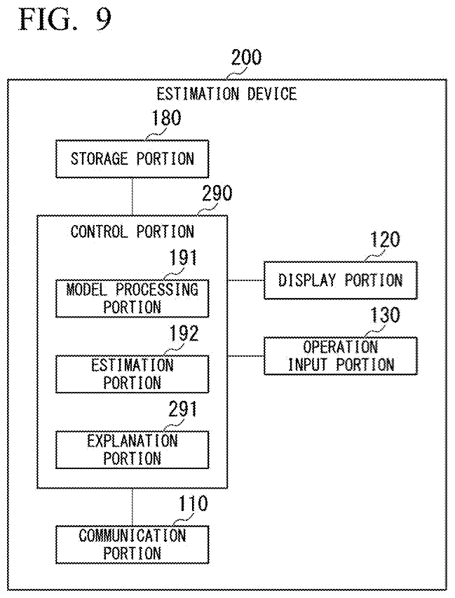

FIG. 9 shows an example of the configuration of the estimation device according to the second example embodiment. In the configuration shown in FIG. 9, the estimation device 200 is provided with a communication portion 110, a display portion 120, an operation input portion 130, a storage portion 180, and a control portion 290. The control portion 290 is provided with a model processing portion 191, an estimation portion 192, and an explanation portion 291.

Parts of FIG. 9 that have similar configurations corresponding to the parts in FIG. 2 are marked with the same reference numerals (110, 120, 130, 180, 190, 191, 192), and detailed explanations thereof shall be omitted here.

The estimation device 200 differs from the estimation device 100 in that the control portion 290 additionally has the explanation portion 291 in addition to the portions of the control portion 190 in FIG. 2. Otherwise, the estimation device 200 is similar to the estimation device 100. The estimation device 200 corresponds to an example of the estimation device 100. The estimation device 200 can be used in place of estimation device 100 in the configuration shown in FIG. 1.

The explanation portion 291 explains the validity of an operation relating to an item based on the estimation results of the estimation portion 192. The explanation portion 291 is an example of an explanation means.

For example, consider the case where the estimation target 900 is a distillation column, and the guide system of the distillation column guides the operator in operating the boiler to achieve a given concentration of the product obtained by distillation. In this case, if the relationship between operating the boiler and changing the product concentration is not clear, it is preferable to be able to explain to the operator the appropriateness of operating the boiler.

If the estimation portion 192 estimates that there is a correlation between operating the boiler and changing the concentration of the product, the result of this estimation can be presented to the operator as an explanation for the appropriateness of operating the boiler.

The estimation device 200 may control the estimation target based on the result of the correlation estimation.

For example, the display portion 120 may display the result of estimating the correlation between items and a screen asking whether or not to adopt the correlation of the estimation result, and the operation input portion 130 may receive a user operation answering whether or not to adopt the correlation of the estimation result. If the operation input portion 130 receives the user operation indicating adoption of the correlation of the estimation result, the control portion 290 may control the estimation target 900 based on the estimation result.

In the distillation column example above, the display portion 120 may display a screen asking if there is a correlation between operating the boiler and changing the concentration of the product, and whether or not to adopt the estimation result of this correlation. If the operation input portion 130 receives a user operation indicating adoption of the estimation result, the control portion 290 may automatically control the boiler.

Alternatively, the estimation device 200 may control the estimation target 900 directly based on the result of the correlation estimation, without performing confirmation to the user.

In the distillation column example above, the control portion 290 may automatically control the boiler based on the result of estimating a correlation between operating the boiler and changing the product concentration.

As described above, the explanation portion 291 explains the validity of an operation on the item based on the estimation result of the estimation portion 192.

This allows the estimation device 200 to explain the validity of an operation without the need to qualitatively analyze the relationship between items.

### Third Example Embodiment

The third example embodiment describes another example of the method of using the estimation device 100 according to the first example embodiment.

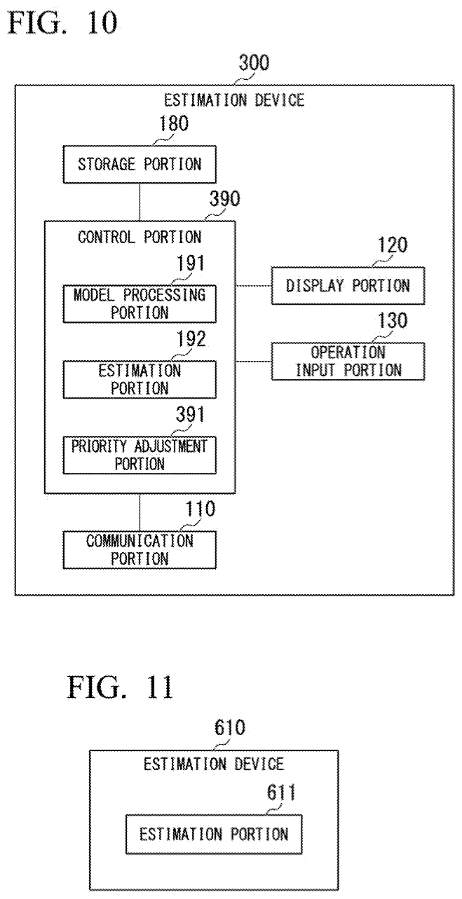

FIG. 10 shows an example of the configuration of the estimation device according to the third example embodiment. In the configuration shown in FIG. 10, an estimation device 300 is provided with the communication portion 110, the display portion 120, the operation input portion 130, the storage portion 180, and a control portion 390. The control portion 390 is provided with a model processing portion 191, an estimation portion 192, and a priority adjustment portion 391.

Those portions of FIG. 10 having similar configurations corresponding to the portions in FIG. 2 are denoted with the same reference numerals (110, 120, 130, 180, 190, 191, 192) and are not described in detail here.

The estimation device 300 differs from the estimation device 100 in that the control portion 390 has the priority adjustment portion 391 in addition to the portions of the control portion 190 in FIG. 2. In other respects, the estimation device 300 is similar to the estimation device 100. The estimation device 300 corresponds to an example of the estimation device 100. The estimation device 300 can be used in place of the estimation device 100 in the configuration shown in FIG. 1.

The priority adjustment portion 391 adjusts the priority of the agent's actions in reinforcement training with respect to the estimation target 900, which is the output source of the past values, based on the estimation result of the estimation portion 192. For example, the priority adjustment portion 391 sets a higher priority for an operation that the estimation portion 192 estimates to be correlated with an item used in the reward function, so that the agent is more likely to select this operation as an action.

The priority adjustment portion 391 corresponds to an example of a priority adjustment means.

When a learning device, such as a controller of an estimation target 900, learns operations on the estimation target 900 by reinforcement learning, the combination of operations on the estimation target 900 is considered to be the agent's behavior. When there are many operable parts in the estimation target 900, the actions that can be performed by the agent increase exponentially. If the proportion of rewarding behaviors among many behaviors is small, learning may not progress.

In contrast, the priority adjustment portion 391 sets a higher priority for an operation that the estimation portion 192 estimates to be correlated with an item used in the reward function, so that the agent is more likely to select this operation as an action. This is expected to increase the frequency with which the agent is rewarded and to promote learning.

It is also expected that by the estimation portion 192 estimating the correlation between items online in parallel with reinforcement learning, the priority adjustment portion 391 can update the priorities in response to dynamic change positions of the correlations during learning, allowing the learner to learn more efficiently.

As described above, the priority adjustment portion 391 adjusts the priority of the agent's actions in reinforcement training with respect to the estimation target 900, which is the output source of the past values, based on the estimation result of the estimation portion 192.

This allows the estimation device 300 to cause the agent to prioritize actions that are more likely to be rewarded, which is expected to advance learning.

### Fourth Example Embodiment

FIG. 11 shows an example of the configuration of the estimation device according to the fourth example embodiment. In the configuration shown in FIG. 11, an estimation device 610 is provided with an estimation portion 611.

In such a configuration, the estimation portion 611 estimates the relationship between items using a prediction model that receives inputs of past values of multiple items or past values of some of those items and outputs predictions for one or more items.

The estimation portion 611 corresponds to an example of an estimation means.

The estimation device 610 can train this prediction model. According to the estimation device 610, in this respect, the relationship between these items can be estimated without the need to build a mathematical model showing the relationship between multiple items.

The estimation portion 611 can be realized, for example, using functions such the estimation portion 192 shown in FIG. 1.

### Fifth Example Embodiment

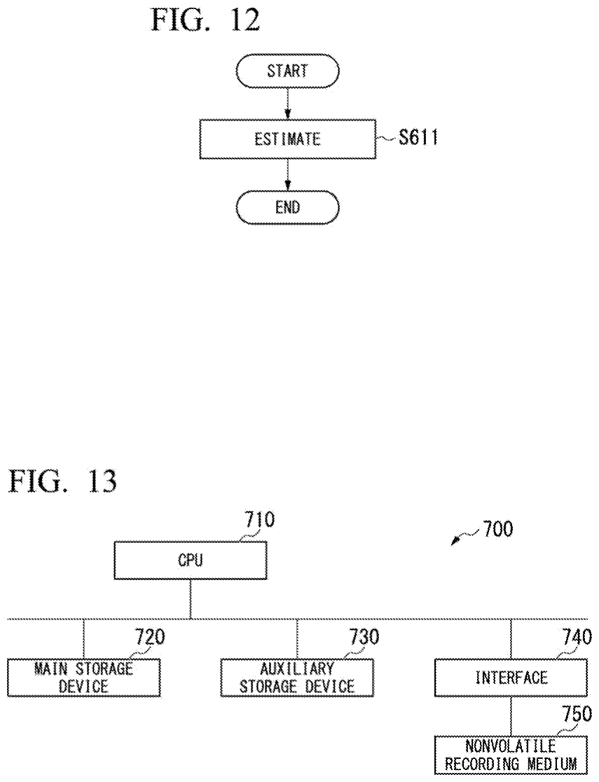

FIG. 12 is a diagram showing an example of the processing procedure in the estimation method according to the fifth example embodiment. The method shown in FIG. 12 includes performing estimation (Step S611).

In performing estimation (Step S611), a computer estimates the relationships among items using a prediction model that receives inputs of past values of multiple items or past values of some of those items and outputs predictions for one or more items.

According to the estimation method shown in FIG. 12, training this prediction model allows the relationship between these items to be estimated without the need to build a mathematical model showing the relationship between multiple items.

FIG. 13 is a schematic block diagram of a computer according to at least one example embodiment.

In the configuration shown in FIG. 13, a computer 700 is provided with a CPU 710, a main storage device 720, an auxiliary storage device 730, an interface 740, and a nonvolatile recording medium 750.

Any one or more of the above estimation devices 100, 200, 300 and 610, or portions thereof, may be implemented in the computer 700. In that case, the operations of each of the above-mentioned processing portions are stored in the auxiliary storage device 730 in the form of a program. The CPU 710 reads the program from the auxiliary storage device 730, deploys the program to the main storage device 720, and executes the above processing according to the program. The CPU 710 also reserves a storage area in the main storage device 720 corresponding to each of the above-mentioned storage portions according to the program. Communication between each device and other devices is performed by the interface 740, which has a communication function and communicates according to the control of the CPU 710. The interface 740 also has a port for the nonvolatile recording medium 750 and reads information from and writes information to the nonvolatile recording medium 750.

When the estimation device 100 is implemented in the computer 700, the operations of the control portion 190 and the various portions thereof are stored in the auxiliary storage device 730 in the form of a program. The CPU 710 reads the program from the auxiliary storage device 730, deploys the program to the main storage device 720, and executes the above processing according to the program.

The CPU 710 also reserves a storage area in the main storage device 720 corresponding to the storage portion 180 according to the program. The communication performed by the communication portion 110 is executed by the interface 740, which has a communication function and communicates according to the control of the CPU 710. The display of images by the display portion 120 is performed by the interface 740, which is equipped with a display device and displays images according to the control of the CPU 710. Reception of a user operation by the operation input portion 130 is performed by the interface 740, which is equipped with an input device to receive user operations.

When the estimation device 200 is implemented in the computer 700, the operations of the control portion 290 and the various portions thereof are stored in the auxiliary storage device 730 in the form of a program. The CPU 710 reads the program from the auxiliary storage device 730, deploys the program to the main storage device 720, and executes the above processing according to the program.

The CPU 710 also reserves a storage area in the main storage device 720 corresponding to the storage portion 180 according to the program. The communication performed by the communication portion 110 is executed by the interface 740, which has a communication function and communicates according to the control of the CPU 710. The display of images by the display portion 120 is performed by the interface 740, which is equipped with a display device and displays images according to the control of the CPU 710. Reception of a user operation by the operation input portion 130 is performed by the interface 740, which is equipped with an input device to receive user operations.

When the estimation device 300 is implemented in the computer 700, the operations of the control portion 390 and the various portions thereof are stored in the auxiliary storage device 730 in the form of a program. The CPU 710 reads the program from the auxiliary storage device 730, deploys the program to the main storage device 720, and executes the above processing according to the program.

The CPU 710 also reserves a storage area in the main storage device 720 corresponding to the storage portion 180 according to the program. The communication performed by the communication portion 110 is executed by the interface 740, which has a communication function and communicates according to the control of the CPU 710. The display of images by the display portion 120 is performed by the interface 740, which is equipped with a display device and displays images according to the control of the CPU 710. Reception of a user operation by the operation input portion 130 is performed by the interface 740, which is equipped with an input device to receive user operations.

When the estimation device 610 is implemented in the computer 700, the operations of the estimation portion 192 are stored in the auxiliary storage device 730 in the form of a program. The CPU 710 reads the program from the auxiliary storage device 730, deploys the program to the main storage device 720, and executes the above processing according to the program.

Communication between the estimation device 610 and other devices is performed by the interface 740, which has a communication function and operates according to the control of the CPU 710.

Interactions between the estimation device 610 and the user are performed by the interface 740, which has an input device and an output device, presenting information to the user with the output device and receiving user operations with the input device according to the control of the CPU 710.

Any one or more of the above programs may be recorded in the nonvolatile recording medium 750. In this case, the interface 740 may read the program from the nonvolatile recording medium 750. The CPU 710 may then directly execute the program read by the interface 740, or may once store the program in the main storage device 720 or the auxiliary storage device 730 and then execute it.

A program for executing all or part of the processing performed by estimation devices 100, 200, 300, and 610 may be recorded on a computer-readable recording medium, and the program recorded on this recording medium may be read into a computer system and executed to perform the processing of each portion. The term “computer system” here shall include an operating system and hardware such as peripherals.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

While the above example embodiments of this invention have been described in detail with reference to the drawings, specific configurations are not limited to these example embodiments, but also include designs and the like to the extent that they do not depart from the gist of this invention.

### INDUSTRIAL APPLICABILITY

The present invention may be applied to an estimation device, an estimation method, and a recording medium.

### DESCRIPTION OF REFERENCE SIGNS

1 System
100, 200, 300, 610 Estimation device
110 Communication portion
120 Display portion
130 Operation input portion
180 Storage portion
190, 290, 390 Control portion
191 Model processing portion
192, 611 Estimation portion
291 Explanation portion
391 Priority adjustment portion

What is claimed is:

1. An estimation device comprising:
at least one memory configured to store instructions; and
at least one processor configured to execute the instructions to:
estimate the relationships among a plurality of items, on the basis of at least one of: the state of a prediction model that receives input of past values of the items or past values of some of the items and then outputs a prediction value for at least one of the items; and differences in the prediction accuracy of the prediction model with respect to different inputs.

2. The estimation device according to claim 1, wherein the at least one processor is configured to execute the instructions to estimate the relationship between a first item and a second item based on the prediction accuracy of the prediction value of the first item output by the prediction model for the input of past values in a combination of items including the first item and the second item, and the prediction accuracy of the prediction value of the first item output by the prediction model for the input of past values of items excluding the second item from the item combination.

3. The estimation device according to claim 1, wherein the prediction model includes a weighting node that performs weighting for past values with a weight of each item, and training of the prediction model includes training of the weight of each item, and
wherein the at least one processor is configured to execute the instructions to estimate the relationship between the items based on the weights in the trained prediction model.

4. The estimation device according to claim 1, wherein the at least one processor is further configured to execute the instructions to perform multiple weightings for multiple items and performs training to predict the value of the same item using the prediction model at each weighting, and
estimate the relationship between the items based on the prediction accuracy of the value of the same item by the trained prediction model with each weighting.

5. The estimation device according to claim 1, wherein the at least one processor is further configured to execute the instructions to explain the validity of an operation with respect to the item based on the estimation result.

6. The estimation device of claim 1, wherein the at least one processor is further configured to execute the instructions to adjust a priority of an agent's action in reinforcement learning with respect to the estimation target, which is the output source of the past values, based on the estimation result.

7. An estimation method executed by a computer, comprising estimating the relationships among a plurality of items, on the basis of at least one of: the state of a prediction model that receives input of past values of the items or past values of some of the items and then outputs a prediction value for at least one of the items; and differences in the prediction accuracy of the prediction model with respect to different inputs.

8. A non-transitory recording medium that records a program for causing a computer to perform a process that estimates the relationships among a plurality of items, on the basis of at least one of: the state of a prediction model that receives input of past values of the items or past values of some of the items and then outputs a prediction value for at least one of the items; and differences in the prediction accuracy of the prediction model with respect to different inputs.
